(19) United States
(12) Patent Application Publication
(10) Pub. No.: US 2003/0219361 A1
(43) Pub. Date: Nov. 27, 2003

(54) Apparatus and method for pretreating effluent gases in a wet environment

(75) Inventors: Byung Il Lee, Gwangju-si (KR); Byung Kwon Yim, Osan-si (KR); Yun Hag Oh, Hwaseong-si (KR); Sung Jin Jung, Daegu (KR); Man Su Lee, Hwaseong-si (KR); Chang Wook Jeong, Seoul (KR); Tae Sang Yoon, Suwon-si (KR); Geun Sik Lee, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: UNISEM Co., Ltd., Hwaseong-si (KR)

(21) Appl. No.: 10/365,492

(22) Filed: Feb. 13, 2003

(30) Foreign Application Priority Data
May 25, 2002 (KR) 2002-0029094

(51) Int. Cl. B01J 10/00

(52) U.S. Cl. 422/171; 422/170; 422/172; 422/173

(57) ABSTRACT

An apparatus and method for wet pre-treatment of an effluent gas derived from upstream semiconductor or LCD manufacturing tools before the effluent gas is processed in an effluent gas treatment system in provided. The apparatus comprises an atomizing spray nozzle for atomizing a reagent and a processing section in which the effluent gas in pre-treated with the atomized reagent using a cyclone method. The processing section comprises an inner tubular portion and an outer tubular portion. The processing section has an effluent gas inlet, a reagent inlet, an effluent gas outlet, and a waste liquid outlet. An apparatus is also provided which includes a plurality of wet pre-treatment units, each of which pre-treat each of effluent gas streams derived from a plurality of CVD chambers.

### FIELD OF THE INVENTION

The present invention relates to an effluent gas treatment, and more particularly, to an apparatus and a method for pre-treating effluent gases from a semiconductor or LCD device manufacturing process in a wet environment.

### BACKGROUND OF THE INVENTION

The effluent gases from semiconductor and LCD device manufacturing processes, such as low pressure chemical vapor deposition, plasma enhanced chemical vapor deposition and plasma etch, may contain toxic, corrosive or explosive gases, such as silane SiH₄, arsine AsH₃, phospine PH₃, diborane B₂H₆, tetraethoxysilan (TEOS) Si(OC₂H₅)₄, ammonia NH₃, boron trichloride BCl₃, chlorine Cl₂, sulfur hexafluoride SF₆, hexa-fluoro ethane C₂F₆ and carbon tetra-fluoride CF₄. Therefore, the effluent gases from these manufacturing processes must be properly treated, before they are released into the open atmosphere.

Particularly, perfluoro-compound (hereinafter “PFC”) gases such as C₂F₆ and CF₄, which are used to clean a CVD process chamber, are known to make significant contributions to global warming because they absorb infrared light and remain in the atmosphere for an extended period of time. Therefore, the reduction of PFC gas emissions is an issue in the semiconductor and LCD industries. In order to address this issue, another PFC gas, NF₃, was introduced as an alternative for CVD chamber cleaning applications.

NF₃ has higher utilization efficiency in cleaning the process chamber than the other PFC gases mentioned above, and rarely generates PFC by-products during the cleaning. Since a method called remote NF₃ chamber cleaning method is known to increase the utilization efficiency of NF₃ and reduce PFC gas emissions, NF₃ has drawn a lot of attention in the semiconductor and LCD industries. However, considering the rapid growth of the semiconductor and LCD industries, the amount of NF₃ used in the cleaning of the CVD chamber is expected to significantly increase, and the proper treatment of NF₃ will become a critical issue. Since NF₃ itself has high utilization efficiency and decompose almost entirely, the solution to this issue lies in treating the corrosive gases, such as F or F₂, generated by the decomposition of NF₃.

The methods that can be used to solve this problem may be classified into three categories: a wet method in which water-soluble components contained in the effluent gases are removed by dissolving the water-soluble components with water; a burning method in which inflammable components of the effluent gas are treated by decomposing or burning them at high temperatures; and an adsorption method in which components that do not burn or are not water-soluble are removed by chemically or physically adsorbing those components through adsorbents. Commercially available systems for treating effluent gases usually employ the combination of the burning method and either the wet method or the adsorption method in view of the safety and cost, rather than employ only one method out of the three methods mentioned above. Particularly, effluent gas treatment systems employing the combined method of the wet method and the burning method (hereinafter “burning-wet treatment system”) are widely used to treat effluent gases.

In the burning-wet treatment system, the effluent gas goes through a burning treatment and subsequent wet treatment. The burning treatment bums the inflammable components contained in the effluent gas. The wet treatment separates the silicon oxide powder produced during the burning treatment and removes the water-soluble components of the effluent gas by spraying water onto the effluent gas.

However, the burning-wet treatment system still has the problems of powder clogging and corrosion, like other types of effluent gas treatment systems. That is, when the effluent gas discharged from the CVD chamber is introduced into the effluent gas treatment system, fine powder contained in the effluent gas gradually adsorbs onto the walls of the chamber for burning treatment, the exhaustion pipe or duct, which results in powder clogging. The powder clogging necessitates frequent maintenance of the effluent gas treatment system. Moreover, corrosive gases, such as F or F₂, contained in the effluent gas easily stick to the walls of the exhaustion pipe or duct and erode the walls, which shortens the life span of the effluent gas treatment system. The increase in maintenance and reduction of the life span of the effluent gas treatment system directly affect the manufacturing costs of semiconductor or LCD devices.

In order to solve these problems, a wet pre-treatment system has been introduced that removes the corrosive gas or fine powder contained in the effluent gas before the effluent gas enters the effluent gas treatment system. Effluent gas treatment systems employing a wet pre-treatment unit are disclosed in U.S. Pat. No. 5,955,037 to Mark Holst et al. and U.S. Pat. No. 5,649,855 to Hiroshi Imamura. U.S. Pat. No. 5,955,037 relates to an effluent gas treatment system that includes a wet pretreatment unit for removing the fine particulates and acidic gas contained in the effluent gas before the effluent gas is introduced into an oxidation chamber. The wet pre-treatment unit disclosed in U.S. Pat. No. 5,955,037 comprises a wet spray tower, which separates and removes the particulates by adsorbing the fine powder of the effluent gas onto water droplets or water vapor to facilitate the agglomeration of the particulates. In detail, water droplets are downwardly introduced into the spray tower through a spray nozzle provided at the upper portion of the spray tower, while the effluent gas is upwardly introduced into the spray tower through an inlet provided at the lower portion of the spray tower. The effluent gas flowing upward in the wet spray tower counter-currently contacts the water droplets to effect initial abatement of fine powder and the acidic gas. Although the wet spray tower is cheap to install and maintain, easy to fix, and has little pressure loss, the short contact time between the water droplets and the effluent gas is problematic to effect a sufficient abatement of fine powder and corrosive gas.

U.S. Pat. No. 5,649,985 relates to a method for effectively removing the harmful substances of exhaust gas discharged during a semiconductor device manufacturing process, and discloses a water scrubber, located upstream of a thermal decomposition unit, for removing at least one of the water-soluble components, hydrolysable components and dust contained in the exhaust gas by water-scrubbing. Especially, U.S. Pat. No. 5,649,985 describes a water scrubber composed of a spray tower and a venturi. The venturi has an upwardly flared portion, a throat portion and a downwardly flared skirt portion. The exhaust gas introduced into the flared portion of the venturi is pretreated with high-pressure water mist sprayed from the spray nozzle provided on a ceiling of the flared portion. Since the high-pressure water mist is compressed into a high-speed flow in the throat portion, and the water mist and the effluent gas flow in the same direction, highly effective contact between the water and the effluent gas can be achieved.

The contact between the water mist and the effluent gas removes the water-soluble components and hydrolysable components and dust from the effluent gas by dissolution or hydrolysis. Although the composite water scrubber disclosed in U.S. Pat. No. 5,649,985 can achieve high treatment efficiency, the pressure drop at the throat due to the fast flow of the water and the effluent gas is a problem. The pressure drop in the water scrubber hinders the effluent gas, thermally decomposed at the downstream oxidation chamber, from discharging out of the oxidation chamber. In order to easily exhaust the thermally decomposed gas out of the oxidation chamber, the effluent gas treatment system disclosed in U.S. Pat. No. 5,649,985 also comprises an exhaust fan. However, the addition of the exhaust fan increases the manufacturing cost of the effluent gas treatment system.

### SUMMARY OF THE INVENTION

Therefore, an objective of the present invention is to provide a wet pre-treatment apparatus for inexpensively and efficiently pre-treating effluent gases from semiconductor or LCD device manufacturing processes.

Another objective of the present invention is to provide a wet pre-treatment apparatus for removing water-soluble components contained in the effluent gases, thereby reducing the treatment burden of the effluent gas treatment system.

Still another objective of the present invention is to provide a wet pre-treatment apparatus for removing fine powder produced in the semiconductor or LCD device manufacturing processes, thereby preventing the powder clogging in the effluent gas treatment system.

Still another objective of the present invention is to provide a wet pre-treatment apparatus for removing corrosive substance such as F₂ generated during the cleaning of a CVD chamber, thereby minimizing corrosion of the effluent gas treatment system.

Still another objective of the present invention is to provide a method for pre-treating water-soluble components and fine powder contained in the effluent gas using a wet pre-treatment apparatus employing cyclone effect.

In accordance with one aspect of the present invention, an apparatus for pre-treating an effluent gas in a wet environment upstream of an effluent gas treatment system is provided which comprises an atomizer for atomizing a reagent, and a processing section comprising an inner tubular member and an outer tubular member. The processing section includes an effluent gas inlet for introducing the effluent gas into the processing section and an atomized reagent inlet for introducing the atomized reagent into the processing section. The effluent gas is pre-treated by the atomized reagent within the processing section. The processing section further includes an effluent gas outlet for discharging the effluent gas pre-treated by with the atomized reagent and a waste liquid outlet for discharging a waste liquid produced by the pre-treatment.

In accordance with another aspect of the present invention, a multi-unit wet pre-treatment apparatus comprising a plurality of wet pre-treatment units is provided to pre-treat effluent gas streams from a plurality of process chambers of semiconductor or LCD manufacturing tools.

In accordance with still another aspect of the present invention, a method for pre-treating an effluent gas in a wet environment before the effluent gas enters an effluent gas treatment system is provided which comprises the steps of introducing the effluent gas into a processing section; introducing an atomized reagent into the processing section; pre-treating the effluent gas with the atomized reagent in the processing section by using cyclone effect to produce a pre-treated effluent gas and a waste liquid; discharging the pre-treated effluent gas through an effluent gas outlet; and discharging the waste liquid through a waste liquid outlet.

### BRIEF DESCRIPTION OF DRAWINGS

The above and other objects and features of the present invention will become apparent from the following description of the embodiments given in conjunction with the accompanying drawings.

FIG. 1 is a schematic diagram of a wet pre-treatment apparatus in accordance with an embodiment of the present invention.

FIG. 2 is a schematic diagram of a wet pre-treatment apparatus in accordance with another embodiment of the present invention.

FIG. 3 is a schematic diagram of a multi-unit wet pre-treatment apparatus in accordance with another embodiment of the present invention.

FIG. 4 illustrates test results on ammonia removal efficiency of the wet pre-treatment method in accordance with the present invention.

### DETAILED DESCRIPTION OF THE PRESENT INVENTION

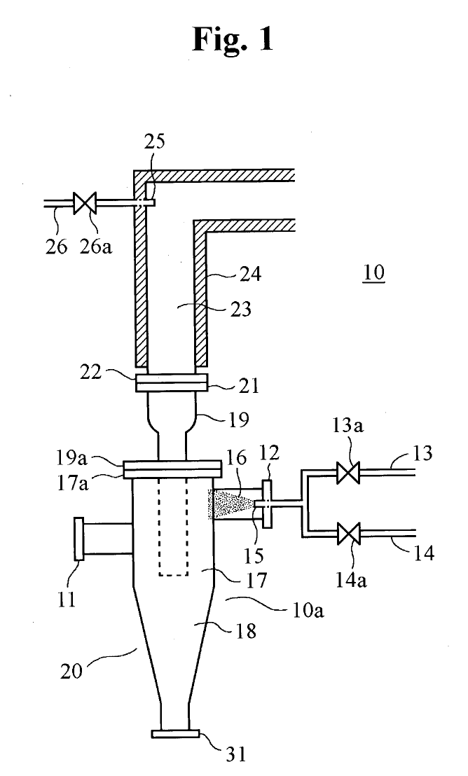

Referring to FIG. 1, wet pre-treatment apparatus 10 of the present invention comprises processing section 20 designed to pre-treat the effluent gas using a cyclone effect and atomizing spray nozzle 15. Wet pre-treatment apparatus 10 of the present invention is constructed to have effluent gas inlet 11, reagent inlet 12, effluent gas outlet 21 for discharging the wet pre-treated effluent gas and waste liquid outlet 31 for draining waste water containing the fine powder and water-soluble components removed from the effluent gas.

Processing section 20 of wet pre-treatment apparatus 10 utilizes a cyclone effect where the centrifugal force of swirling fluids separates solid particulates or liquid droplets dispersed in the fluids. Water-soluble constituents and fine powder are separated from the effluent gas by spraying the reagent onto the effluent gas swirling inside processing section 20. Processing section 20 comprises inner tubular member 19 and outer tubular member 10a, where outer tubular member 10a has upper cylindrical portion 17 and lower conical portion 18. Thus, processing section 20 of wet pre-treatment apparatus 10 has the general shape of an upside bottle down. Connector 17a provided at the top of upper cylindrical portion 17 connects inner tubular member 19 and outer tubular member 10a. Waste liquid outlet 31 is installed at the bottom of lower conical portion 18. The length of outer tubular member 10a increases the contact time between the effluent gas and the reagent. However, the length of outer tubular member 10a must be adjusted to maximize the cyclone effect.

Inner tubular member 19 has the general shape of a funnel, comprised of an upper cylindrical portion, a tapering portion following the upper cylindrical portion and a lower cylindrical portion following the tapering portion. Effluent gas outlet 21 is installed at the top of inner tubular member 19. Connector 19a for connecting inner tubular member 19 and outer tubular member 10a is provided right below the tapering portion of inner tubular member 19. Inner tubular member 19 extends to the lower end of upper cylindrical portion 17 of outer tubular member 10a so that even when the reagent is sprayed widely in the longitudinal direction by atomizing spray nozzle 15, the pre-treated effluent gas does not contact the reagent again before being discharged through effluent gas outlet 21. By interconnecting connector 17a and connector 19a, inner tubular member 19 and outer tubular member 10a are interconnected. The interconnection is made with, for example, a clamp to allow an easy maintenance of the wet pre-treatment apparatus in case of powder clogging. A part of inner tubular member 19 projected into outer tubular member 10a is shown by the broken lines in FIG. 1, and the detailed structure of the interconnection is not shown in the drawings for clarity.

Effluent gas inlet 11 for introducing the effluent gas discharged from an upstream main chamber for CVD is installed at the outer wall of upper cylindrical portion 17 of outer tubular member 10a. Effluent gas inlet 11 is constructed so that the effluent gas is introduced perpendicular to the normal direction of upper cylindrical portion 17 of outer tubular member, i.e., tangential to the outer wall of upper cylindrical portion 17 of outer tubular member 10a. Effluent gas inlet 11 and reagent inlet 12 are constructed so that the effluent gas and the reagent flow concurrently inside processing section 20, which would maximize the cyclone effect by allowing the effluent gas and the reagent to rotate in the same direction. Reagent inlet 12 is arranged above effluent gas inlet 11 to improve the pre-treatment efficiency of the effluent gas.

Atomizing spraying nozzle 15 for atomizing the reagent in order to increase the pre-treatment efficiency is installed at reagent inlet 12. Two inlet pipes 13 and 14, one for a gas and the other for the reagent, are connected to atomizing spray nozzle 15 in a direct compressing way. The inlet pipes are respectively provided with valves 13a and 14a to control the flow of the gas and reagent. The distal end of nozzle 15 extends into reagent inlet 12 so that atomized reagent 16 is sprayed into processing section 20 to react with the effluent gas.

Dehumidifier 23 is installed above effluent gas outlet 21 arranged at the top of inner tubular member 19 of processing section 20. Dehumidifier 23 and inner tubular member 19 of processing section 20 are connected by coupling effluent gas outlet 21 with dehumidifier inlet 22. Coupling effluent gas outlet 21 and dehumidifier inlet 22 with a clamp is preferable. Dehumidifier 23 is a cylindrical pipe interconnecting effluent gas outlet 21 of wet pre-treatment apparatus 10 and the effluent gas treatment system (not shown), the outer wall of which is uniformly heated by heater 24. Compressed gas provider 25 is installed at dehumidifier 23 to introduce compressed gas into dehumidifier 23. Compressed gas provider 25 is preferably arranged so that the compressed gas injected into dehumidifier 23 reaches an inlet of the effluent gas treatment system. Compressed gas provider 25 includes gas pipe 26 and valve 26a interlocked therewith. The inlet of the effluent gas treatment system, the effluent gas treatment system and a reservoir are not illustrated in the drawings for clarity.

Coating portions of the wet pre-treatment apparatus and the pipe that contact the corrosive effluent gas with a polymer, e.g. a fluorine resin such as TEFLON™ to prevent the corrosion is preferable.

The wet pre-treatment method of the effluent gas using wet pre-treatment apparatus 10 in accordance with the present invention shall be explained in detail below.

The effluent gas generated from the manufacturing processes of semiconductor or LCD devices is introduced into the wet pre-treatment apparatus of the present invention through effluent gas inlet 11 with the introduction direction thereof being tangential to the outer wall of upper cylindrical portion 17 of outer tubular member 10a. Atomized reagent 16 for pre-processing the effluent gas is introduced into wet pre-treatment apparatus 10 through reagent inlet 12 provided at the outer wall of upper cylindrical portion 17 of outer tubular member 10a with the introduction direction being tangential to the outer wall of upper cylindrical portion 17. As described above, the atomized reagent flows concurrently with the effluent gas.

The reagent used in wet pre-treatment apparatus 10 in accordance with the present invention includes neutral water, tap water, diluted solution of NaOH or CaOH₂, and electrolyzed water. The reagent is fed into atomizing spray nozzle 15 through reagent inlet pipe 14. When neutral water is used as the reagent, neutral water is introduced into nozzle 15 at a flow rate of about 100 to 500 cc/min, or more preferably 200 to 500 cc/min. Since the preferred flow rate of neutral water is less than 500 cc/min, wet pre-treatment apparatus 10 in accordance with the present invention can minimize the amount of waste-water while enhancing the treatment efficiency of the effluent gas. Therefore, the wet pre-treatment method in accordance with the present invention is environmentally friendly, reduces reagent usage, and lowers the manufacturing costs of semiconductor or LCD devices.

The wet pre-treatment method using neutral water as reagent shall be explained below.

Wet pre-treatment apparatus 10 uses atomizing spray nozzle 15 of a direct compression type as a fine droplet generator in order to improve the treatment efficiency of the effluent gas. The reagent is atomized in atomizing spray nozzle 15 and is sprayed into processing section 20 through reagent inlet 12. When neutral water is used as a reagent, neutral water is atomized into fine droplets less than 50 umin in size, which is ten times smaller than the droplet size atomized in a conventional way.

A finely atomized reagent increases the treatment efficiency of the effluent gas because the treatment efficiency depends on the contact area between the reagent and the effluent gas, and on the temperature of the reagent, in the following ways. First, a finely atomized reagent increases the total surface area thereof and thus enhances the chances of contacting with the effluent gas. Second, the atomizing process of the reagent in atomizing spray nozzle 15 is a pseudo-adiabatic expansion process. Accordingly, the temperature of the reagent decreases in the atomizing process, which increases the solubility of the water-soluble gaseous components of the effluent gas in the reagent.

Nitrogen gas is introduced into atomizing spray nozzle 15 through gas inlet pipe 13 with a flow rate of about 5 to 20 lpm, more preferably about 10 to 20 lpm.

Valves 13a and 14a arranged upstream of the inlet pipes control the flow rate of the reagent and nitrogen gas so that the direct pressure provided by nozzle 15 atomizes the reagent and the atomized reagents are sprayed into processing section 20 through reagent inlet 12 in a full conical shape.

Wet pre-treatment apparatus 10 pre-treats the effluent gas using the cyclone effect. The reagent introduced through reagent inlet 12 descends, rotating along the inner wall of outer tubular member 10a. As the effluent gas descends through lower conical portion 18 of outer tubular member 10a, the rotation speed of the effluent gas increases since outer tubular member 10a tapers but the centrifugal forces must remain constant, which achieves the maximum separating effect. The fine powder contained in the effluent gas are separated and collected at lower end of lower conical portion 18 of outer tubular member 10a by the operation of centrifugal force and gravity. The water-soluble gaseous components of the effluent gas dissolve in the reagent and are collected at the lower end of lower conical portion 18 by the operation of centrifugal force and gravity. Since the effluent gas and the reagent descend along the inner wall of outer tubular member 10a, the contact time between the effluent gas and the reagent increases. Moreover, the concurrent flows of the effluent gas and the reagent maximize the cyclone effect.

Wet pre-treatment apparatus 10 employing the cyclone method has technical advantages over the wet pre-treatment apparatuses employing the spray tower method (U.S. Pat. No. 5,955,037) and the venturi method (U.S. Pat. No. 5,649,985) as follows. The cyclone method achieves much higher treatment efficiency of the effluent gas than the spray tower method. In the wet pre-treatment apparatus employing the spray tower method disclosed in U.S. Pat. No. 5,955,037, the effluent gas flows counter-currently to the reagent, which reduces the contact time between the effluent gas and the water droplets, thereby degrading the treatment efficiency. The apparatus employing the venturi method disclosed in U.S. Pat. No. 5,649,985 can achieve higher treatment efficiency than the apparatus of the present invention, because the effluent gas flows concurrently with the reagent, and the reagent is compressed while passing through the venturi throat. However, the venturi method has the disadvantage of large pressure loss. The venturi type apparatus is known to have ten times higher pressure loss than the spray tower type apparatus. In contrast, apparatus 10 of the present invention employing the cyclone method has a smaller pressure loss than the venturi type apparatus so that it obviates the need for an additional ventilation fan, unlike the apparatus disclosed in U.S. Pat. No. 5,649,985.

Separated fine powder, waste liquid (such as the reagent in which the water-soluble gaseous components are dissolved), and sludgy precipitates are discharged through waste liquid outlet 31 and collected at the reservoir (not illustrated). The effluent gas pre-treated at processing section 20 forms an ascending swirling flow at the center of the processing section and moves up along the inner tubular member 19 and is discharged through outlet 21 to the effluent gas treatment system.

The pre-treated gas discharged from effluent gas outlet 21 passes through dehumidifier 23, which is surrounded by heater 24, and flows into the effluent gas treatment system. The pre-treated effluent gas tends to include a large amount of entrained reagent and water vapor. Dehumidifier 23 prevents the highly humid effluent gas from eroding heater 24 of the effluent gas treatment system and thus increases the life span of the effluent gas treatment system. Dehumidifier 23 uses gravity to reduce the humidity of the effluent gas. That is, effluent gas containing a lot of droplets cannot pass through dehumidifier 23 due to the force of gravity exerted thereon and is collected at the bottom end of lower conical portion 18 of outer tubular member 10a and drains through waste liquid outlet 31. The pre-treated effluent gas can be further dehumidified by injecting dry gas into dehumidifier 23 through compressed gas provider 25. Valve 26a controls the flow rates of the dry gas. Nitrogen gas or clean, dry air can be used as a dry gas, but heated nitrogen gas is preferred.

Compressed gas provider 25 installed at dehumidifier 23 can be used to achieve another objective. As the pre-treated effluent gas is introduced into the effluent gas treatment system, the effluent gas may react with oxygen gas at the entrance of the effluent gas treatment system to form powder and cause powder clogging. The compressed gas injected toward the inlet of the effluent gas treatment system can remove powder to suppress powder clogging at the inlet of the effluent gas treatment system. In order to achieve these objectives, compressed gas provider 25 is preferably directed towards the inlet of the effluent gas treatment system. Nitrogen gas or clean dry air can be used as a compressed gas, but heated nitrogen gas is preferred.

Heater 24 is installed to prevent the pre-treated effluent gas from being deposited on the pipes while flowing to the effluent gas treatment system. Relatively humid pre-treated gas may be deposited on the cold pipes to cause powder clogging. Heater 24 is preferably kept in a temperature range of about 50° C. to 200° C., more preferably about 100° C. to 150° C .

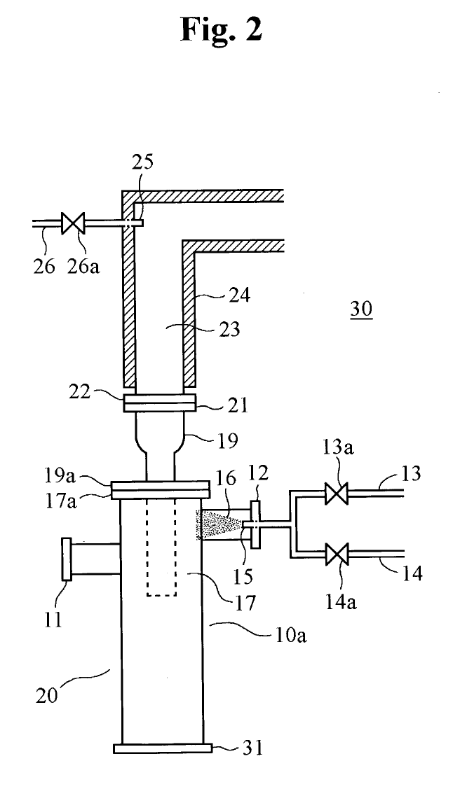

Referring to FIG. 2, wet pre-treatment apparatus 30 has the same structure as apparatus 10 shown in the FIG. 1, except for processing section 20, which brings about the cyclone effect. While outer tubular member 10a of apparatus 10 of FIG. 1 has upper cylindrical portion 17 and lower conical portion 18, outer tubular member 10a of apparatus 30 of FIG. 2 is comprised only of a straight cylindrical portion. Since outer tubular member 10a of wet pre-treatment apparatus 30 has a straight cylinder shape, the rotating speed of the effluent gas does not increase as the effluent gas descends along outer tubular member 10a of apparatus 30. Accordingly, processing section 20 of apparatus 30 cannot achieve as large a separation effect as that of apparatus 10.

Although the straight cylinder shape of outer tubular member 10a of apparatus 30 degrades the pre-treatment efficiency of the effluent gas, it allows reduction of the manufacturing cost of the wet pre-treatment apparatus because an outer tubular member having a straight cylinder shape is much cheaper to manufacture than a outer tubular member having an upper cylindrical portion and a lower conical portion. The reduction of manufacturing cost of the wet pre-treatment apparatus lowers the manufacturing costs of semiconductor or LCD devices.

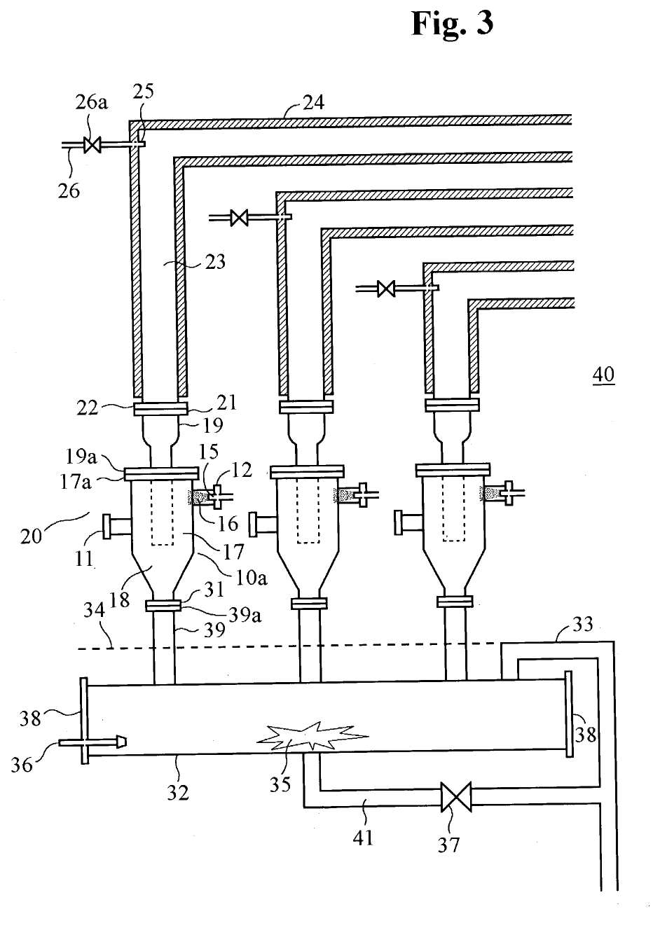

Referring FIG. 3, exemplary multi-unit apparatus 40 comprises three wet pre-treatment units 10, each of which has the same structure. In FIG. 3, gas inlet pipe 13, reagent inlet pipe 14 and the valves interlocked therewith have been omitted for clarity. Outer tubular member 10a of wet pre-treatment unit 10 may have a straight cylindrical shape as shown in FIG. 2 to reduce the manufacturing cost of the apparatus.

Still referring to FIG. 3, multi-unit apparatus 40 comprises pre-reservoir 32, which is a cylindrical tank arranged upstream of the reservoir. Each wet pre-treatment unit 10 is connected to pre-reservoir 32 by coupling waste liquid outlets 31 to interconnecting pipes 39. Liquid level maintaining means 33 comprising an overflow pipe is installed on the top of pre-reservoir 32 to maintain the level of neutral water held in pre-reservoir 32 to a predetermined level. Preferably, the liquid level maintaining means 33 is arranged above the top of pre-reservoir 32. Liquid level maintaining means 33 preferably extends vertically up to the predetermined liquid level located between waste liquid outlet 31 and pre-reservoir 32, then extends parallel to pre-reservoir 32, and then extends downward, surrounding pre-reservoir 32, to the reservoir.

Drainage conduit 41 is installed at the bottom of pre-reservoir 32 and extends through valve 37 to meet the pipe of liquid level maintaining means 33. These pipes connecting pre-reservoir 32 and the reservoir preferably have a straight-line shape in order to suppress powder clogging. Sealing ports 38 are provided at the sides of pre-reservoir 32, and compressed fluid provider 36 for the pre-reservoir is constructed at one port 38.

Multi-unit wet pretreatment apparatus 40 is used to pre-treat a plurality of effluent gas streams from a plurality of chambers of semiconductor or LCD device manufacturing tools. Each chamber of semiconductor or LCD device manufacturing tools uses different reagent gases to deposit different substances. A separate pre-treatment unit corresponding to each chamber of the manufacturing tools is required to prevent unexpected explosive reactions among the different effluent gas streams and to suppress powder clogging. Therefore, the number of units in the multi-unit wet pre-treatment apparatus depends on the number of chambers in the semiconductor or LCD device manufacturing tools.

A wet pre-treatment method using multi-unit wet pre-treatment apparatus 40 shall be explained in detail below.

Each effluent gas stream derived from each CVD chamber undergoes the same wet pre-treatment before it gets to the effluent gas treatment system as explained in connection with FIG. 1. Therefore, only the procedure after the waste liquid is discharged through waste liquid outlet 31 shall be described.

Pre-reservoir 32 is constructed to effectively remove powder discharged from wet pre-treatment units 10. The absence of pre-reservoir 32, as in the case of apparatuses 10 and 20 shown in FIGS. 1 and 2, causes powder clogging because the conduits or pipes extending from waste liquid port 31 to the reservoir cannot be straight, and curved conduits or pipes make it hard for the waste liquid containing powder to pass there-through to the reservoir. Accordingly, the provision of pre-reservoir 32 upstream of the reservoir allows effective suppression of powder clogging.

The powder is removed in pre-reservoir 32 by the following procedure. Pre-reservoir 32 holds the waste liquid discharged through the waste liquid outlet 31 and the reagent such as neutral water. The powder contained in the waste liquid accumulates at the bottom of pre-reservoir 32 owing to the difference in specific weight. When the powder accumulates to a certain level, compressed fluid is injected into pre-reservoir 32 through compressed fluid provider 36 to make the powder uniformly dispersed in the neutral water. The compressed fluid injected into pre-reservoir 32 includes nitrogen or clean dry air. Neutral water instead of compressed gas may be used to stir up the powder.

When valve 37 interlocked with compressed fluid provider 36 is open, the powder dispersed in the neutral water flows to the reservoir through conduit 41. Since the powder is uniformly dispersed in the neutral water, the powder can be removed more effectively than in an apparatus without a pre-reservoir. Periodic injection of compressed fluid and opening of valve 37 facilitate the removal of powder 35 in pre-reservoir 32 and thus the maintenance of apparatus 40. Powder 35 accumulated in pre-reservoir 32 may be removed by periodic opening of sealing ports 38.

The level of neutral water held in pre-reservoir 32 is preferably kept at predetermined level 34 shown in FIG. 3. The waste liquid discharged through waste liquid outlet 31 is collected in pre-reservoir 32. When the level of the waste liquid exceeds predetermined level 34, the extra waste liquid above predetermined level 34 flows to the reservoir to keep constant the waste liquid level in pre-reservoir 32. Preferably pre-reservoir 32 is filled to its capacity during the operation of apparatus 40 because the effluent gas streams passing through each wet pre-treatment unit 10 of apparatus 40 may contact each other in the pre-reservoir 32 to cause an explosive reaction or powder clogging.

As described above, the apparatus in accordance with the present invention can achieve the following advantages.

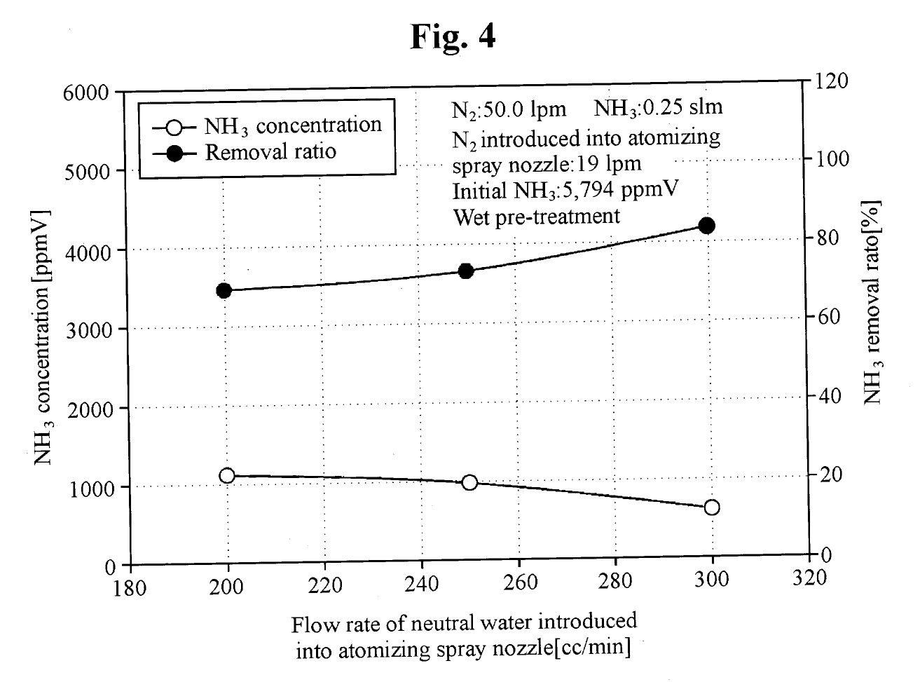

First, the wet pre-treatment apparatus can significantly reduce the amount of water-soluble components contained in the effluent gas, by about 80%, before the effluent gas flows into the effluent gas treatment system. For example, referring to FIG. 4, 80% of F₂ gas or ammonia gas derived from an upstream CVD chamber was removed as the effluent gas passed through the wet pre-treatment apparatus, which significantly suppressed the introduction of corrosive F₂ gas into the effluent gas treatment system and the formation of nitrogen compounds in the effluent gas treatment system. This in turn unloads the treatment burden of the effluent gas treatment system and suppresses the discharge of hazardous substances into the atmosphere.

Still referring to FIG. 4, the dependence of ammonia concentration after the wet pre-treatment and corresponding ammonia removal ratio on the flow rate of neutral water introduced into the atomizing spray nozzle is shown, where the initial ammonia concentration is 5,794 ppmV and the flow rate of nitrogen introduced into the atomizing spray nozzle is 19 lpm. The ammonia removal ratio does not change greatly with the flow rate of the neutral water, but reaches 80% when the flow rate of the neutral water is 300 cc/min. Since the apparatus of the present invention removes fine powder before it reaches the effluent gas treatment system, powder clogging in the effluent gas treatment system can be significantly suppressed.

Second, the wet pre-treatment apparatus of the present invention significantly reduces the treatment burden of the effluent gas treatment system. Based on the result shown in FIG. 4, the wet pre-treatment apparatus unloads the treatment burden of the effluent gas treatment system by 80%, which increases the lifetime of constituent parts of the effluent gas treatment system and thus cuts down the maintenance cost. This also increases the uptime of the effluent gas treatment system and thus reduces the manufacturing costs of semiconductor or LCD devices.

Third, the wet pre-treatment apparatus of the present invention removes corrosive gases, particularly fluorine gas, discharged during the manufacturing of semiconductor or LCD devices. Therefore, the apparatus in accordance with the present invention can efficiently treat NF₃ gas used to clean the main CVD chamber in semiconductor or LCD manufacturing processes. Accordingly, the effluent gas treatment systems used in the semiconductor or LCD manufacturing processes an expected to adopt the wet pre-treatment apparatus of the present invention in order to pre-treat NF₃ gas.

While the present invention has been shown and described herein with respect to the particular embodiments, those skilled in the art will recognize that many exchanges and modifications may be made without departing from the spirit and scope of the invention as defined in the appended claims.

What is claimed is:

1. An apparatus for pre-treating an effluent gas in a wet environment upstream of an effluent gas treatment system comprising:
an atomizer for atomizing a reagent; and
a processing section comprising an inner tubular member and an outer tubular member,
wherein the processing section includes an effluent gas inlet for introducing the effluent gas into the processing section and an atomized reagent inlet for introducing the atomized reagent into the processing section, the effluent gas being pre-treated by the atomized reagent within the processing section, and
wherein the processing section further includes an effluent gas outlet for discharging the effluent gas pre-treated by the atomized reagent and a waste liquid outlet for discharging a waste liquid produced by the pre-treatment.

2. The apparatus of claim 1, wherein the outer tubular member comprises an upper cylindrical portion and a lower conical portion.

3. The apparatus of claim 1, wherein the outer tubular member has a cylindrical shape.

4. The apparatus of any one of claims 1-3, further comprising:
a dehumidifier for reducing humidity of the pre-treated effluent gas discharged from the effluent gas outlet, the dehumidifier being arranged between the effluent gas outlet and the effluent gas treatment system; and
a heater installed at an outer wall of the dehumidifier.

5. The apparatus of claim 4, wherein the dehumidifier comprises a compressed gas provider for providing a compressed gas having low humidity into the dehumidifier.

6. A multi-unit wet pre-treatment apparatus comprising a plurality of the apparatuses recited in any one of claims 1-3.

7. The apparatus of claim 6, further comprising:
a dehumidifier for reducing humidity of the pre-treated effluent gas discharged from the effluent gas outlet, the dehumidifier being arranged between the effluent gas outlet and the effluent gas treatment system; and
a heater installed at an outer wall of the dehumidifier.

8. The apparatus of claim 7, further comprising:
a pre-reservoir for holding the waste liquid discharged from the waste liquid outlet before the waste liquid is drained into a reservoir;
a liquid level maintaining means for filling the pre-reservoir with the waste liquid during the operation of the apparatus; and
a compressed fluid provider for providing a compressed fluid into the pre-reservoir.

9. The apparatus of claim 7 or 8, wherein the dehumidifier comprises a compressed gas provider for providing a compressed gas having low humidity into the dehumidifier.

10. A method for pre-treating an effluent gas in a wet environment before the effluent gas enters an effluent gas treatment system, the method comprising the steps of:
introducing the effluent gas into a processing section;
introducing an atomized reagent into the processing section;
pre-treating the effluent gas with the atomized reagent in the processing section by using cyclone effects to produce a pre-treated effluent gas and a waste liquid;
discharging the pre-treated effluent gas through an effluent gas outlet; and
discharging the waste liquid through a waste liquid outlet.

11. The method of claim 10, wherein the atomized reagent is made of at least one of neutral water, tap water, diluted solution of NaOH or CaOH₂ and electrolyzed water.

12. The method of claim 10, wherein the step of introducing the atomized reagent comprises atomizing neural water having a flow rate of about 100 to 500 cc/min by using a nitrogen gas having a flow rate of about 5 to 20 lpm.

13. The method of claim 10, further comprising, prior to the step of discharging the waste liquid, the steps of:
dehumidifying the pre-treated effluent gas discharged from the effluent gas outlet; and
heating the dehumidified pre-treated effluent gas.

14. The method of claim 13, wherein the step of heating comprises heating the dehumidified pre-treated effluent gas with a heater kept in a temperature range of about 50° C. to 200° C.
